(19) United States
(12) Patent Application Publication
(10) Pub. No.: US 2007/0076172 A1
(43) Pub. Date: Apr. 5, 2007

(54) Projection assembly

(76) Inventors: Scott Lerner, Corvallis, OR (US); Anurag Gupta, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/244,725

(22) Filed: Oct. 5, 2005

(51) Int. Cl. G03B 21/00

(52) U.S. Cl. 353/31

(57) ABSTRACT

A projection assembly is provided herein. According to one exemplary embodiment, the projection assembly includes a plurality of modulator panels in optical series, a color combiner, and at least one field lens associated with at least one of the modulator panels. Further, according to one exemplary embodiment, the field lens is located between the modulator panel and the color combiner.

### BACKGROUND

A conventional system or device for displaying an image, such as a television monitor, projector, or other imaging system, is frequently used to display a still or video image. Viewers evaluate display systems based on many criteria such as image size, contrast ratio, color purity, brightness, pixel color accuracy, and resolution. Image brightness, pixel color accuracy, and resolution are particularly important metrics in many display markets because the available brightness, pixel color accuracy, and resolution can limit the size of a displayed image and control how well the image can be seen in venues having high levels of ambient light.

Many digital display systems create a full-color display by creating three or more modulated images in primary colors (red, green, and blue) per video frame using corresponding modulator panels. Such systems frequently combine the different colored light with a prism before the light is directed to a projection lens. Differences in how wavelengths interact with lenses may result in aberrations. Relatively large lenses may be used to correct each of the aberrations.

### SUMMARY

A projection assembly is provided herein. According to one exemplary embodiment, the projection assembly includes a plurality of modulator panels in optical series, a color combiner, and at least one field lens associated with at least one of the modulator panels. Further, according to one exemplary embodiment, the field lens is located between the modulator panel and the color combiner.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 illustrates a display system according to one exemplary embodiment.

FIG. 2 is a flowchart illustrating a method of modulating light according to one exemplary embodiment.

FIG. 3 illustrates a projection assembly according to one exemplary embodiment.

FIG. 4 illustrates a projection assembly according to one exemplary embodiment.

Throughout the drawings, identical reference numbers designate similar, but not necessarily identical, elements.

### DETAILED DESCRIPTION

Light modulator assemblies are provided herein for use in a display system. In particular, light modulator assemblies are provided herein that include a plurality of modulator panels with at least one field lens assembly associated with each of the modulator panels. According to one exemplary embodiment, the light modulator assembly includes a color combiner. The field lenses are located between each modulator panel and the color combiner. As a result, light from each modulator panel passes through the associated field lens and then is directed to the color combiner.

The configuration of the light modulator assemblies allows the output of each modulator panel to be independently controlled. For example, each field lens may be adjusted to control axial color, or color-dependent focus. Further, lateral color, or color-dependent magnification, can be corrected by having independent field lenses and/ or independent focusing for each modulator panel. The field lenses may also allow for a beam splitter and other lens components to be smaller, thus reducing cost.

In the following description, for purposes of explanation, numerous specific details are set forth in order to provide a thorough understanding of the present method and apparatus. It will be apparent, however, to one skilled in the art, that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Display System

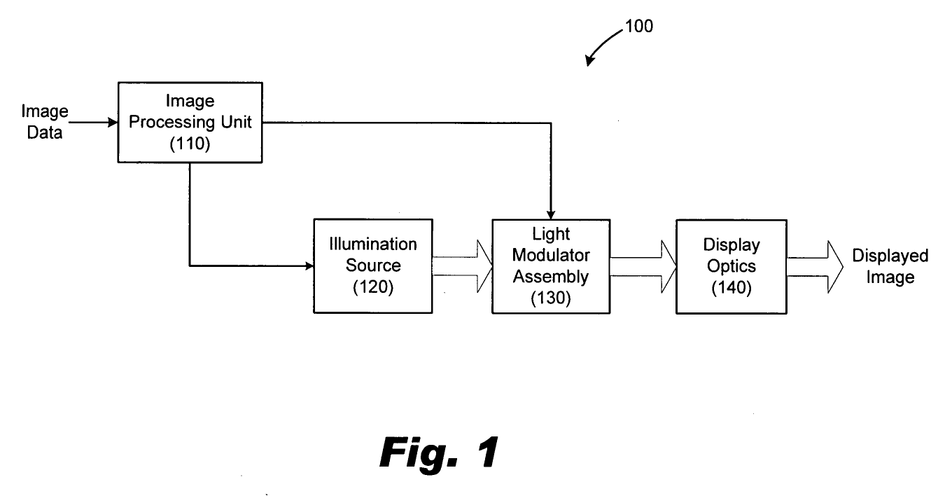

FIG. 1 illustrates an exemplary display system (100). The components of FIG. 1 are exemplary only and may be modified or changed as best serves a particular application. As shown in FIG. 1, image data is input into an image processing unit (110). The image data defines an image that is to be displayed by the display system (100).

While one image is illustrated and described as being processed by the image processing unit (110), it will be understood by one skilled in the art that a plurality or series of images may be processed by the image processing unit (110). The image processing unit (110) performs various functions including controlling an illumination source (120) and a light modulator assembly (130).

The display system (100) also includes an illumination source (120). The illumination source (120) generates multi-component light. The multi-component light produced by the illumination source (120) is split into individual components.

These components are then directed to the light modulator assembly (130). The light modulator assembly (130) includes a plurality of individual modulator panels. The individual components directed to the light modulator assembly (130) are directed to corresponding modulator panels. The incident light on each of the modulator panels may be modulated in its frequency, phase, intensity, polarization, or direction by the modulator panels. Each modulator panel forms a single sub-image.

Each modulator panel then directs the sub-images to associated field lenses. The field lenses may each direct the light independently to correct aberrations or abnormalities elsewhere in the display system, such as in display optics (140). The output of the field lenses is directed to the display optics (140).

The display optics (140) may include any device configured to display or project an image. For example, according to one exemplary embodiment, the display optics (140) include, but are not limited to, a lens assembly that includes a plurality of lenses in optical communication with each of the light modulator panels. The lens assembly is configured to focus the individual sub-images to form a single full-color image and to display the full-color image onto a viewing surface. The viewing surface may be, but is not limited to, a screen, television such as a rear projection-type television, wall, liquid crystal display (LCD), or computer monitor.

Method of Modulating Light

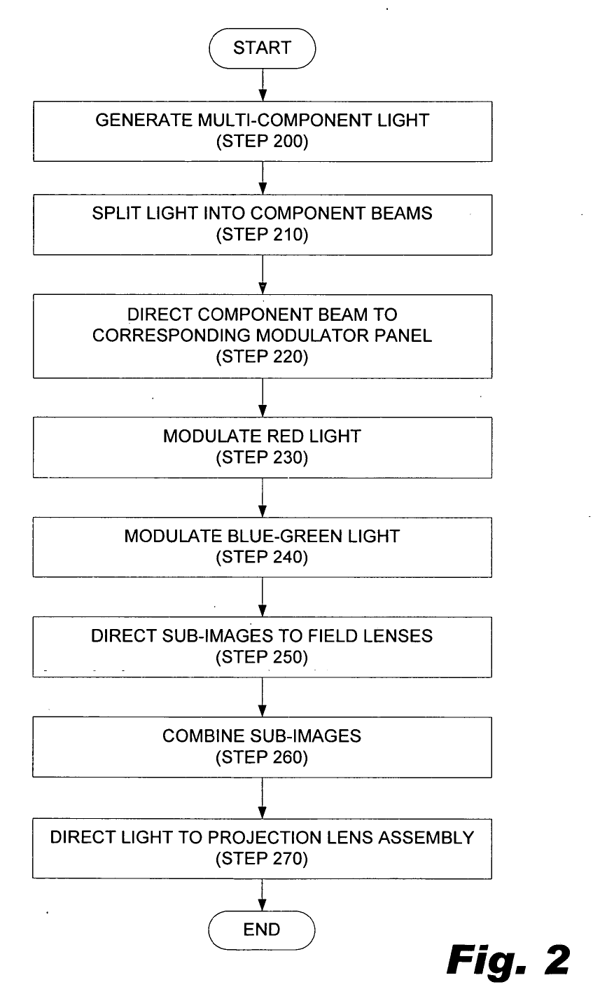

FIG. 2 illustrates a method of modulating light. The method begins by generating multi-component light (step 200). The multi-component light may be generated by any suitable illumination source, such as a xenon gas or mercury arc bulb coupled to a reflector.

Light produced by the illumination source is then split into a plurality of component beams (step 210). According to one exemplary method the component beams include red and blue-green component beams. The component beams may be split in any suitable way. For example, dichroic mirrors or filters may be used to split the multi-component light. As the multi-component light is split into individual component beams, each individual component beam is directed to a corresponding modulator panel (step 220).

Each component beam is then modulated by an associated modulator. For example, according to the present exemplary process, red light is modulated by a red modulator (step 230), blue-green light is modulated by a blue-green modulator (step 240). These steps occur substantially simultaneously such that the light modulated by each modulator panel corresponds to one part, or sub-image, of a single full-color image or series of images.

In particular, the modulator panels are configured to modulate light in response to data from an image processing unit. The data sent to each modulator panel corresponds to the formation of a sub-image. Each modulator may be a reflective—and/or an interference-type light modulator that modulates the light in response to the data to form the sub-images.

The sub-images are directed from each of the modulator panels to associated field lenses (step 250). As introduced, the field lenses may be independently focused to optimize the output of the display system. The light from the field lenses is then combined (step 260). For example, the light may be directed to a color combiner, such as a dichroic cross or prism. The combined light is then directed to a projection lens assembly (step 270), which directs the light to a display surface. One exemplary projection assembly will be discussed in more detail below.

Projection Assembly

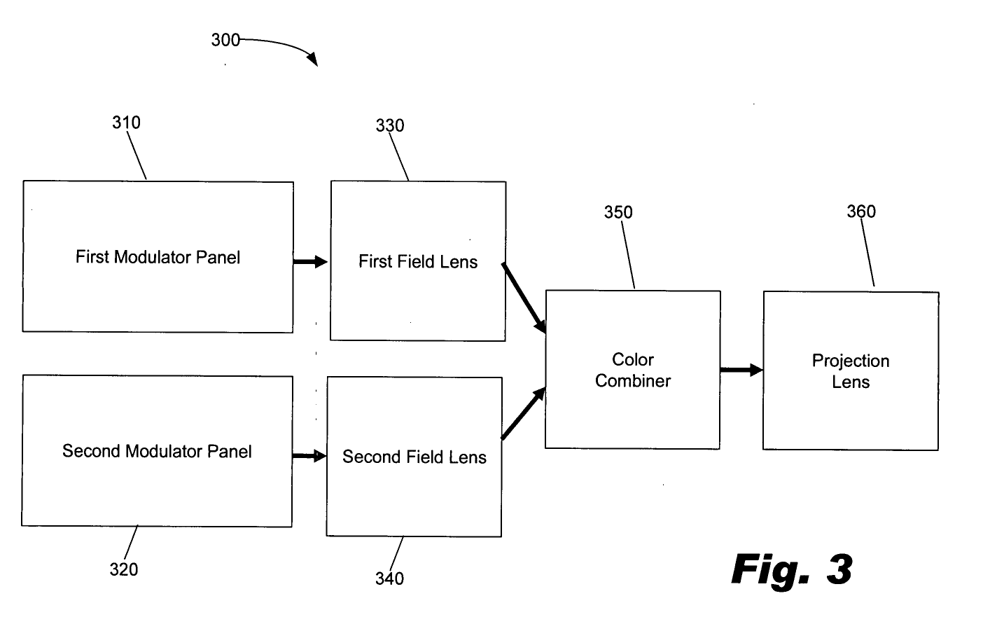

FIG. 3 is a schematic view of an exemplary projection assembly (300). As shown in FIG. 3, the projection assembly (300) generally includes a plurality of modulator panels. For ease of reference, two modulator panels will be described, including a first modulator panel (310) and a second modulator panel (320). The projection assembly (300) also includes first and second field lenses (330, 340) associated with the first and second modulator panels (310, 320 respectively).

First and second component beams are directed to the first and second modulator panels (310, 320). The modulator panels (310, 320) modulate the component beams incident thereon to form individual sub-images. Each modulator panel includes an array of individual pixels. Each pixel modulates light incident thereon to form a portion of a sub-image. By properly controlling each of the pixels, an entire sub-image may be formed.

The sub-images are directed to a corresponding field lens, such as first and second field lenses (330, 340). As introduced, the field lenses (330, 340) may be independently focused to correct aberrations in other parts of the display system, such as in a projection lens (360). In particular, each field lens may be adjusted to control axial color, or color-dependent focus. For example, aberrations such as chromatic blurring due to the inability of a lens to bring all of the colors into a common focus may result in a slightly different image size and focal point for the output of each modulator panel. Such an aberration is frequently known as axial color. The field lenses (330, 340) may be controlled independently to reduce or eliminate differences in the focus of each modulator panel. Accordingly, the field lenses (330, 340) may be used to reduce chromatic blurring due to differences in the focus due to axial color.

Further, lateral color, or color-dependent magnification can be corrected by having independent field lenses and/or independent focusing, or magnification for each modulator panel. Obliquely incident light leads to the transverse chromatic aberration, also known as lateral color. Lateral color refers to sideways-displaced foci. The occurrence of lateral color implies that the magnification of each sub-image depends on the wavelength. Accordingly, the field lenses (330, 340) may be independently controlled to lateral color. Additionally, other wavefront aberrations may also be corrected with the additional degrees of freedom that the field lenses provide. Thus, the field lenses may also allow for a beam splitter and other lens components to be smaller because each aberration may be independently corrected and focused smaller outside of the projection lens (360).

The color combiner (350) is in optical communication with each of the first and second field lenses (330, 340). Accordingly, the color combiner (350) receives the output of the field lenses (330, 340). The color combiner (350) combines the individual sub-images to form a full-color image. The full-color image is then directed to the projection lens (360). The projection lens (360) directs the full-color image to a display surface, where the full-color image is displayed.

Series Projection Assembly

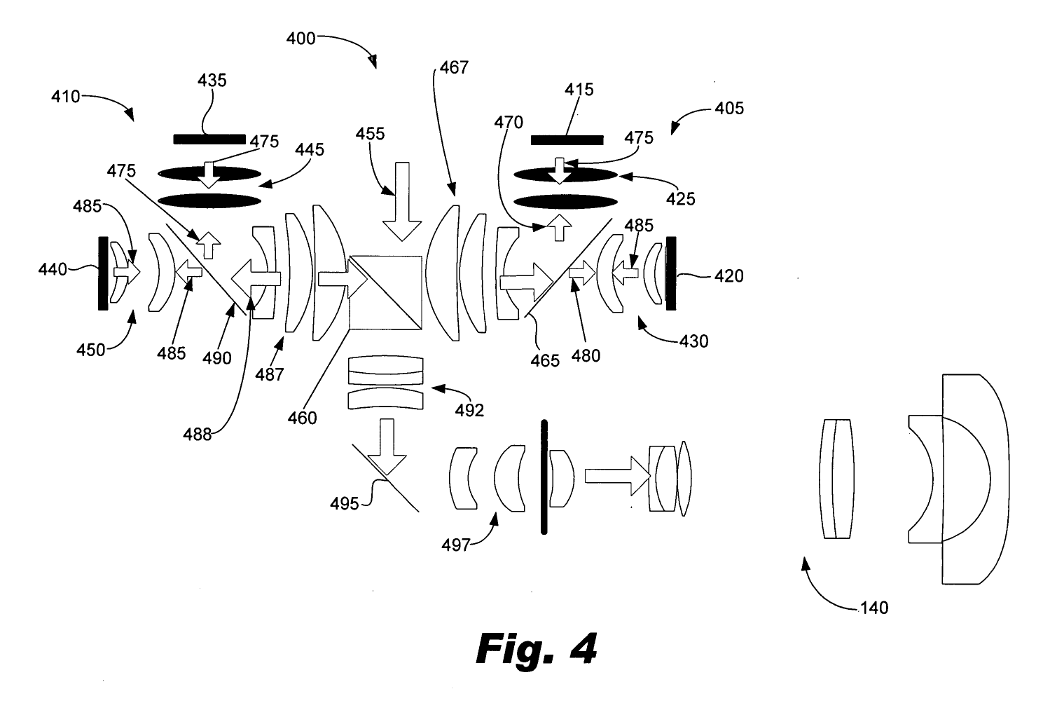

FIG. 4 illustrates an exemplary projection assembly (400) in more detail. In particular, the projection assembly (400) shown in FIG. 4 includes a first modulator assembly (405) and a second modulator assembly (410) that are placed in optical series. According to such a configuration, light entering the projection assembly (400) is modulated by the first modulator assembly (405). The light is then directed to the second modulator assembly (410), where it is again modulated. By modulating each image or sub-image in series, the projection assembly (400) may produce an image with enhanced contrast ratio. In particular, the contrast ratio of each modulator assembly is related, at least in part, to the extinction ratio of the pixels in each modulator assembly. The extinction ratio is the ratio of light transmitted by a pixel in a fully activated state relative to the light transmitted by a pixel in a fully-deactivated or off state. By modulating the light more than once, as light is again modulated a decreased amount of light is transmitted from a pixel in the off state. The decrease of transmitted light from the pixel in the off state increases the extinction ratio and consequently the contrast ratio of the projection assembly (400).

Each modulator assembly (405, 410) includes a plurality of modulator panels. The first modulator assembly (405) includes a first single-color modulator panel, such as a modulator panel (415) and a first two-color modulator panel, such as a blue-green modulator panel (420). For ease of reference, single-color modulator panels and components associated therewith will be discussed as red modulator panels and components while two-color modulator panels will be discussed as blue-green modulator panels and components. Those of skill in the art will appreciate that other configurations are possible.

First field lenses, such as a first red field lens and a first blue-green field lens (425, 430) are associated with the first red and blue-green modulator panels (415, 420). The second modulator assembly (410) includes a second red modulator panel (435) and a second blue-green modulator panel (440). Second field lenses, such as a second red field lens and a second blue-green field lens (445, 450) are associated with the second red modulator panel (435) and the second blue-green modulator panel (440) respectively. As will be discussed in more detail below, the first and second field lenses (425, 430, 445, 450) may each be independently adjusted to optimize the output of the projection assembly (400). The operation of the projection assembly (400) will now be discussed in more detail.

As seen in FIG. 4, multi-component polarized light, such as linearly polarized white light (455) is directed to a directing member, such as a polarized beam splitter (PBS) (460). For ease of reference, polarized white light of an initial polarization and orientation will be described. Those of skill in the art will appreciate other configurations are possible. The PBS (460) is configured to reflect the initially polarized and oriented white light (455) directed thereto toward the first modulator assembly (405). More specifically, the PBS (460) directs the polarized white light (455) to a first dichroic mirror (465). In particular, the polarized white light (455) passes through a first coupling lens assembly (467). The first coupling lens assembly (467) focuses the polarized white light (455) onto the first dichroic mirror (465).

The first dichroic mirror (465) according to the present exemplary embodiment is configured to reflect a red component beam (470). In particular, according to the present exemplary embodiment, the red component beam (470) is directed through the first red field lens (425). The first red field lens (425) directs the red component beam (470) to the first red modulator panel (415).

The first red modulator panel (415) modulates the red component beam (470) to form a red sub-image (475). According to one exemplary embodiment, the red modulator panel (415) is an interference-type modulator panel. As the red modulator panel (415) modulates the red component beam (470), the red modulator panel changes the polarization of the red sub-image relative to the red-component beam (470). In particular, according to one exemplary embodiment, the red modulator panel (415) includes a ¼ wave plate. As the light enters the red modulator panel (415), the ¼ wave plate rotates polarization orientation of the entering light by 45 degrees. The red light is then modulated to form a red sub-image (475). As the red sub-image image (475) exits the red modulator panel (415), the ¼ wave plate again rotates the polarization orientation by another 45 degrees, such that the red sub-image has a polarization orientation that is rotated by 90 degrees relative to the red component beam (470).

The red sub-image (475) is then directed back through the first red field lens (425). The focus of the red field lens (425) may be adjusted as desired to minimize color aberrations due to differences in axial color, lateral color, and/or other types of aberrations. The red field lens (425) directs the red sub-image (475) to the first dichroic mirror (465). As introduced, the first dichroic mirror (465) is configured to reflect red light. Thus, the red sub-image (475) is reflected by the first dichroic mirror (465). The red sub-image (475) travels back through the first coupling lens assembly (467) to the PBS (460).

As previously discussed, the PBS (460) is configured to reflect light with the polarization of the initially polarized and oriented white light (455). Also as previously discussed, the red sub-image (475) has a polarization that is rotated 90 degrees relative to the orientation of the white light (455). The orientation of the red sub-image (475) allows the red sub-image (475) to be transmitted through the PBS (460).

As previously discussed, the white light (455) that enters the PBS (460) is initially directed to the first coupling lens assembly (467). The first coupling lens assembly (467) then direct the white light (455) to the first dichroic mirror (465). As discussed, the first dichroic mirror (465) reflects red light. The first dichroic mirror (465) also transmits a blue-green component beam (480). The blue-green component beam (480) is directed to the first blue-green field lens (430).

The blue-green field lens (430) then directs the blue-green component beam (480) to the first blue-green modulator panel (420). The first blue-green modulator panel (420) modulates blue-green light to form a blue-green sub-image (485). According to the present exemplary embodiment, as the blue-green modulator panel (420) modulates blue-green light, the first blue-green modulator panel (420) rotates the polarization orientation of the light by 90 degrees. For example, the polarization orientation may be thus rotated by passing the blue-green component beam (480) through a ¼ wave plate as it enters the first blue-green modulator panel to rotate the polarization orientation by 45 degrees. Thereafter, as the blue-green sub-image (485) exits the first blue-green modulator panel (420), it again passes through the ¼ wave plate. The second pass through the ¼ wave plate rotates the polarization orientation another 45 degrees. As a result, the blue-green sub-image (485) has a polarization orientation that is rotated 90 degrees relative to the blue-green component beam (480).

The blue-green sub-image (485) is then directed back through the first blue green field lens (430). The focus of the blue-green field lens (430) may be independently adjusted to correct aberrations, as previously discussed. The blue-green field lens (430) then directs the light back through the first coupling lens assembly (467) to the PBS (460).

The blue-green sub-image (485) has substantially the same orientation as the red sub-image (475). Accordingly, both the red sub-image (475) and the blue-green sub-image (485) are transmitted through the PBS (460). The combination of the two sub-images may be referred to as a full-color image (488). The PBS (460) transmits the full-color image (488) to a second coupling lens assembly (487).

The second coupling lens assembly (487) then directs the red and blue-green sub-images (475, 485) to the second modulator assembly (410). More specifically, the second coupling lens assembly (487) directs the red and blue-green sub-images (475, 485) to a second dichroic mirror (490). The second dichroic mirror (490) reflects the red sub-image (475) and transmits the blue-green sub-image (485).

The red sub-image (475) is directed to the second red field lens (445). The second red field lens (445) in turn directs the red sub-image (475) to the second red modulator panel (435). The second red modulator panel (435) again modulates the red sub-image (475) to thereby refine it. Further, as the second red modulator panel (435) modulates the red sub-image (475), the second red modulator panel (435) again rotates orientation of the red sub-image 90 degrees, such as through the use of a ¼ wave plate as previously discussed.

The red sub-image (475) is then directed back through the second red field lens (445). The second red field lens (445) may also be independently focused to correct aberrations. Thus, each of the red field lenses (425, 445) may independently direct light to correct aberrations. The second red field lens (445) directs the red sub-image (475) back to the second dichroic mirror (490).

As introduced, the blue-green sub-image (485) is transmitted through the second dichroic mirror (490). The blue-green sub-image (485) is then directed to the second blue-green field lens (450). The second blue-green field lens (450) directs the blue-green sub-image (485) to the second blue-green modulator panel (440).

The second blue-green modulator panel (440) refines the blue-green sub-image (485) while rotating the polarization orientation thereof 90 degrees, such as with a ¼ wave plate as previously discussed. The second blue-green modulator panel (440) then directs the blue-green sub-image (485) through the second blue-green field lens (450). The second blue-green field lens (450) may also be independently adjusted to correct aberrations.

The blue-green sub-image (485) is transmitted through the second dichroic mirror (490). The transmitted blue-green sub-image (485) and the reflected red sub-image (475) are then again combined into the full-color image (488). The full-color image (488) is then incident on the PBS (460). As discussed, the second red and blue-green modulators (435, 440) rotate the orientation of the light while refining the images. As a result, the full-color image (488) has the same orientation of the white light (455) entering the projection assembly (400). Thus, the PBS (460) reflects the full-color image (488).

The PBS (460) directs the full-color image (488) to a first eye-piece lens (492). The first eye-piece lens (492) focuses the full-color image (488) onto a directing member, such as a wobbling mirror (495). The wobbling mirror (495) may be coupled to a wobulation control system, which causes the wobbling mirror (495) to selectively spatially shift the path of the full-color image (488) to increase the resolution of the displayed image. Wobulator control, or wobulation, refers to a process of shifting the position of a light path relative to the wobbling mirror plate (495). In other words, the imaging processing unit (110; FIG. 1) shifts the position of the wobbling polarized plate (495) such that each light from each pixel of each of the modulator panels is displayed in a slightly different spatial position. This concept is discussed in United States Published Patent Application 20040028293 filed Aug. 7, 2002, U.S. Publication Application 20040027313, filed Sep. 11, 2002, now U.S. Pat. No. 6,817,722, which are hereby incorporated by reference in their entirety.

The wobbling mirror (495) directs the full-color image (488) to a second eye-piece lens (497). The second eye-piece lens then directs the full-color image (488) to the display optics (140). The display optics (140) direct the full-color image to a display surface, where the full-color image (488) is displayed.

In conclusion, light modulator assemblies are provided herein for use in a display system. In particular, the light modulator assemblies provided herein include a plurality of modulator panels with at least one field lens assembly associated with each of the modulator panels. According to one exemplary embodiment, the light modulator assembly includes a color combiner. The field lenses are located between each modulator panel and the color combiner. As a result, light from each modulator panel passes through the associated field lens and is then directed to the color combiner.

The configuration of the light modulator assemblies allows the output of each modulator panel to be independently controlled. For example, each field lens may be adjusted to control axial color, or color-dependent focus. Further, lateral color, or color-dependent magnification can be corrected by having independent field lenses and/ or independent focusing for each modulator panel. Additionally, other wavefront aberrations may also be corrected with the additional degrees of freedom that the field lenses provide. The field lenses may also allow for a beam splitter and other lens components to be smaller, thus reducing cost.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. A projection assembly, comprising:
a plurality of modulator panels in optical series;
a color combiner; and
at least one field lens associated with at least one of said modulator panels and being located between said modulator panel and said color combiner.

2. The assembly of claim 1, wherein each of said modulator panel includes a field lens associated therewith and located between said modulator panel and said color combiner.

3. The assembly of claim 1, wherein said plurality of modulator panels includes first and second modulator panels and said field lens is associated with said first modulator panel, and further comprising a second field lens associated with said second modulator panel.

4. The assembly of claim 1, wherein said plurality of modulator panels includes at least one single-color modulator panel and at least one two-color modulator panel.

5. The assembly of claim 1, wherein said plurality of modulator panels includes first and second modulator assemblies in series.

6. The assembly of claim 5, wherein said first modulator assembly includes a first dichroic mirror, a first single-color modulator panel and a first single-color field lens located between said first dichroic mirror and said first single-color modulator panel, and a first two-color modulator panel and a first two-color field lens located between said first dichroic mirror and said first two-color modulator panel.

7. The assembly of claim 5, wherein said second modulator assembly includes a second dichroic mirror, a second single-color modulator panel and a second single-color field lens located between said second dichroic mirror and said second single-color modulator panel, and a second two-color modulator panel and a second two-color field lens located between said second dichroic mirror and said second two-color modulator panel.

8. The assembly of claim 5, and further comprising a polarizing beam splitter located at least partially between said first and second light modulator assemblies.

9. The assembly of claim 5, and further comprising a wobbling mirror coupled to said second light modulator assembly, said wobbling mirror being configured to selectively spatially shift a path of light from said light modulator assembly.

10. A display system, comprising:
an image processing unit;
at least one illumination source;
a plurality of modulator panels in optical series, said plurality of modulator panels being in optical communication with said illumination source;
a color combiner;
at least one field lens located between said modulator panels and said color combiner; and
display optics in optical communication with said color combiner.

11. The display system of claim 10, wherein said modulator panels comprise interference modulator panels.

12. The system of claim 10 wherein said modulator panels comprise red and blue-green modulator panels.

13. The system of claim 10, wherein said plurality of modulator panels includes a plurality of light modulator assemblies.

14. The assembly of claim 13, wherein said light modulator assemblies are in series.

15. The assembly of claim 10, and further comprising a wobbling mirror coupled to said image processing unit, said wobbling mirror being configured to selectively spatially shift an output of said modulator panels.

16. A method of modulating light, comprising:
generating multi-component light;
splitting said multi-component light into a plurality of component beams; and
modulating said component beams with a plurality of modulator panels in optical series to form a plurality of sub-images; and
independently adjusting a focus of at least one of said sub-images.

17. The method of claim 16, and further comprising combining said sub-images to form a full-color image.

18. The method of claim 17, wherein combining said sub-images includes combining said sub-images on a display surface.

19. The method of claim 17, wherein combining said sub-images includes combining said sub-images with a color combiner.

20. The method of claim 18, wherein forming said plurality of sub-images includes forming red and blue-green sub-images.

21. The method of claim 16, and further comprising refining said plurality of sub-images.

22. The method of claim 17, and further comprising spatially shifting a path of said sub-images.

23. A system, comprising:
means for generating multi-component light;
a plurality of modulator means in optical series for modulating said multi-component light; and
means for independently adjusting an output of at least one of said modulator means.

24. The system of claim 23, and further comprising means for splitting said multi-component light between said means for generating multi-component light and said plurality of modulator means.

25. The system of claim 23, and further comprising means for combining said output of modulator means.
